(19) United States
(12) Patent Application Publication
(10) Pub. No.: US 2022/0148143 A1
(43) Pub. Date: May 12, 2022

(54) IMAGE FUSION METHOD BASED ON GRADIENT DOMAIN MAPPING

(71) Applicant: MOONLIGHT (NANJING) INSTRUMENT CO., LTD., Jiangsu (CN)

(72) Inventors: Xinyu PENG, Jiangsu (CN); Wei ZHOU, Jiangsu (CN)

(73) Assignee: MOONLIGHT (NANJING) INSTRUMENT CO., LTD., Jiangsu (CN)

(21) Appl. No.: 17/581,995

(22) Filed: Jan. 24, 2022

Related U.S. Application Data
(63) Continuation-in-part of application No. PCT/CN2020/091354, filed on May 20, 2020.

(30) Foreign Application Priority Data
Jul. 31, 2019 (CN) 201910705298.9

(51) Int. Cl. G06T 5/50

(52) U.S. Cl. CPC G06T 5/50; G06T 2207/20221

(57) ABSTRACT

The disclosure of an image fusion method based on gradient domain mapping, which comprises: inputting a plurality of to-be-fused images to a processor of a computer by an input unit of the computer, and performing the following steps by the processor of the computer: performing gradient domain transform on the plurality of to-be-fused images, extracting the maximum gradient modulus value in the plurality of images corresponding to each pixel point in a gradient domain as the gradient value of final fused image at the pixel point, traversing each pixel point to obtain the gradient domain distribution of the final fused image, and mapping the plurality of to-be-fused images into the same spatial domain according to the obtained gradient domain distribution to obtain a fused image; and outputting the fused image obtained by the processor by an output unit of the computer.

### CROSS-REFERENCE TO RELATED APPLICATION

This is a continuation-in-part application of International Application No. PCT/CN2020/091354, filed on May 20, 2020, which claims the priority benefits of China Application No. 201910705298.9, filed on Jul. 31, 2019. The entirety of each of the above-mentioned patent applications is hereby incorporated by reference herein and made a part of this specification.

### TECHNICAL FIELD

The present invention relates to an image fusion algorithm, in particular to an image fusion algorithm based on gradient domain mapping, and belongs to the technical field of image processing.

### BACKGROUND

The image fusion is to fuse a plurality of images of the same target scene into an image containing rich information by using a given method, and the fused image comprises all information of the original images. At present, the image fusion technology has been widely applied to the fields of medicine, remote sensing and the like.

The structure of image fusion is generally divided into three levels: pixel-level fusion, feature-level fusion and decision-level fusion. The pixel-level fusion is the simplest and most direct fusion method, specifically, image data obtained from an image sensor is directly processed to obtain a fused image, and the fusion algorithm comprises a principal components analysis (PCA), a wavelet decomposition fusion method and the like; the feature-level fusion firstly obtains different features of the image, and then uses certain algorithms to fuse the features of the image; and the decision-level fusion is the highest level fusion, and the fusion method comprises decision-level fusion based on a Bayesian method and the like.

### SUMMARY

In order to solve the technical problem, the present invention provides an image fusion method based on gradient domain mapping, which extracts a clear image information and maps the information into a spatial domain based on gradient domain, thereby generating a picture containing detailed information of objects at different depths in the shooting direction by fusing a plurality of images under the shooting condition of small depth of field.

In order to solve the aforementioned technical problems, the present invention adopts the following technical scheme:

the present invention provides an image fusion method based on gradient domain mapping, which comprises:

step 1, inputting a plurality of to-be-fused images to a processor of a computer by an input unit of the computer, and performing the following steps by the processor of the computer: performing gradient domain transform on the plurality of to-be-fused images, extracting the maximum gradient modulus value in the plurality of images corresponding to each pixel point in a gradient domain as the gradient value of final fused image at the pixel point, traversing each pixel point to obtain the gradient domain distribution of the final fused image, and mapping the plurality of to-be-fused images into the same spatial domain according to the obtained gradient domain distribution to obtain a fused image; and

step 2, outputting the fused image obtained by the processor by an output unit of the computer.

In the image fusion method based on gradient domain mapping, performing the steps by the processor specifically comprises:

(1) obtaining gray image information of each image from the plurality of to-be-fused images:

fₙ(x,y),(x<K,y<L),n=1, 2, . . . , N

wherein, (x,y) is the pixel coordinate of the gray image, K and L are the boundary values of the image in X and Y directions, respectively, and N is the total number of the images;

(2) constructing the gradient domain of N images by using Hamiltonian

$$Δ = \frac{\partial }{\partial x} \vec{i} + \frac{\partial }{\partial y} \vec{j} \text{:} grand {f}_{n} ( x , y ) = Δ \cdot {f}_{n} ( x , y ) = \frac{\partial {f}_{n} ( x , y )}{\partial x} \vec{i} + \frac{\partial {f}_{n} ( x , y )}{\partial y} \vec{j}$$

wherein, ī, j̅ are unit direction vectors along X and Y directions, respectively, and |grand fₙ(x,y)| is a modulus of the gradient in the gradient domain;

(3) extracting the maximum gradient modulus value corresponding to the pixel point (x,y) in the N images according to the modulus |grand fₙ(x,y)| of the gradient in the gradient domain, taking the maximum modulus value as the gradient value of the final image at the point (x,y), traversing each pixel coordinate (x,y), and finally generating the fused gradient domain distribution at all the pixel points by adopting the method:

grand fₙ(x, y)→grand f(x,y); and

(4) traversing each pixel point (x,y) according to the gradient domain distribution obtained in the step (3), selecting the pixel point value of the image corresponding to the gradient domain as the pixel point of the fused image at the pixel point, realizing that the N images are mapped into the same spatial domain through the gradient domain distribution, and obtaining the fused image:

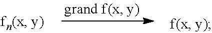

wherein, fₙ(x,y) is the fused gray image obtained after mapping.

In the step (1), the number of the plurality of images N is greater than or equal to 2.

In the step (1), the plurality of fused images have the same field of view and resolution.

In the step (1), the plurality of images have different focus depths for objects at different depth positions or the same object.

Beneficial Effects: the image fusion method disclosed by the present invention fuses a plurality of images at different focus positions to generate an image with clear details of objects at different focus positions; since the gradient value reflects the change size (detailed information) of the image at the point, mapping the corresponding gray value by selecting the maximum gradient modulus value to extract the detailed information at different positions, so that pictures with the detailed information of objects at different positions are synthesized by using a plurality of pictures having the same resolution with the same shooting environment and field of view without replacing cameras and lens, and therefore a quick and convenient image fusion method is provided for the application fields of computer vision detection and the like.

### BRIEF DESCRIPTION OF THE DRAWINGS

FIG. 1 is a diagram of a system structure corresponding to the image fusion method based on gradient domain mapping according to the present invention;

FIG. 2 is a flowchart of the image fusion method based on gradient domain mapping according to the present invention;

FIG. 3 are to-be-fused images in the same field of view with the same camera shooting different focal planes in the present invention;

FIG. 4 are images of gradient domain modulus value distribution corresponding to the three images in FIG. 3;

FIG. 5 is a gradient domain image obtained by fusing the three images of gradient domain modulus value distribution in FIG. 4; and

FIG. 6 is a spatial domain image reconstructed by mapping the gradient domain image in FIG. 5.

### DETAILED DESCRIPTION OF THE EMBODIMENTS

The present invention will be better understood from the following embodiments. However, it is easily understood by those skilled in the art that the descriptions of the embodiments are only for illustrating the present invention and should not and will not limit the present invention as detailed in the claims.

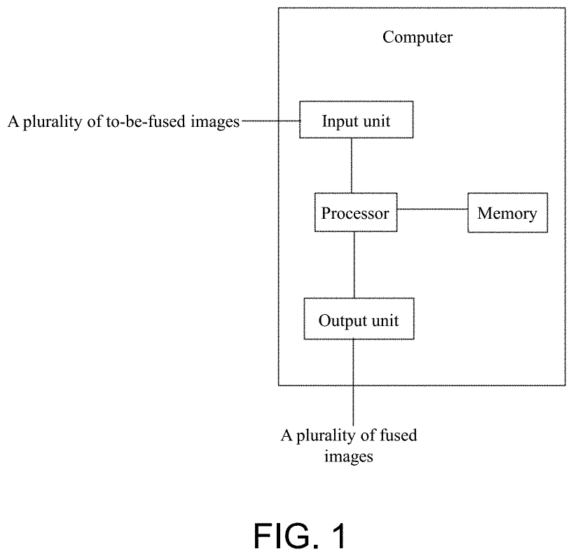

As shown in FIG. 1, the image fusion method based on gradient domain mapping of the present invention comprises:

step 1, inputting a plurality of to-be-fused images to a processor of a computer by an input unit of the computer, and performing the following steps by the processor of the computer: performing gradient domain transform on the plurality of to-be-fused images, extracting the maximum gradient modulus value in the plurality of images corresponding to each pixel point in a gradient domain as the gradient value of final fused image at the pixel point, traversing each pixel point to obtain the gradient domain distribution of the final fused image, and mapping the plurality of to-be-fused images into the same spatial domain according to the obtained gradient domain distribution to obtain a fused image; and

step 2, outputting the fused image obtained by the processor by an output unit of the computer.

The input unit and the output unit are an input interface and an output interface of the processor, respectively, and the input interface and the output interface can be a network communication interface, a USB serial port communication interface, a hard disk interface and the like.

The image fusion method of the present invention extracts a clear image information and maps the information into a spatial domain based on the gradient domain, thereby generating a picture containing detailed information of objects at different depths in the shooting direction by fusing a plurality of images under the shooting condition of small depth of field. The algorithm of the present invention requires to shoot N images in different depth directions (Z direction) within the same field of view by changing focus positions of lens. Because of the limitation of the depth of field of the lens, each image can be clearly focused on the image plane (X, Y direction) only at a small depth in front and back near the focus plane. In order to display three-dimensional (X, Y, Z direction) information of a photographed object (or space) on one picture, N images are fused to generate one image. Detailed information (X, Y direction) of objects at different depth positions can be obtained from the image.

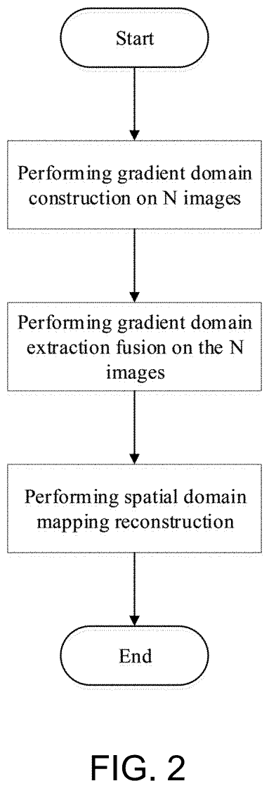

As shown in FIGS. 2-6, in the image fusion method based on gradient domain mapping of the present invention, performing the steps by the processor specifically comprises:

(1) obtaining gray image information of each image from the plurality of to-be-fused images:

fₙ(x,y),(x<K,y<L),n=1, 2, . . . , N

wherein, (x,y) is the pixel coordinate of the gray image, K and L are the boundary values of the image in X and Y directions, respectively, N is the total number of the images, and N is greater than or equal to 2; the plurality of images have the same field of view and resolution; the plurality of images have different focus depths for objects at different depth positions or the same object;

(2) constructing the gradient domain of N images by using Hamiltonian

$$Δ = \frac{\partial }{\partial x} \vec{i} + \frac{\partial }{\partial y} \vec{j} \text{:} grand {f}_{n} ( x , y ) = Δ \cdot {f}_{n} ( x , y ) = \frac{\partial {f}_{n} ( x , y )}{\partial x} \vec{i} + \frac{\partial {f}_{n} ( x , y )}{\partial y} \vec{j}$$

wherein, ī, j̅ are unit direction vectors along X and Y directions, respectively, |grand fₙ(x,y)| is a modulus of the gradient in the gradient domain, and reflects the change size of the gray scale at the point, and the larger the modulus is, the more obvious the gradient transform at the point is, and the richer the detailed information of the corresponding image is;

(3) extracting the maximum gradient modulus value corresponding to the pixel point (x,y) in the N images according to the modulus |grand fₙ(x,y)| of the gradient in the gradient domain, taking the maximum modulus value as the gradient value of the final image at the point (x,y), traversing each pixel coordinate (x,y), and finally generating the fused gradient domain distribution at all the pixel points by adopting the method:

grand fₙ(x, y)→grand f(x, y); and

(4) performing the spatial domain mapping reconstruction step, wherein the fused gradient image has the maximum gradient modulus value at each point, and the corresponding spatial information is richest; traversing each pixel point (x,y) according to the gradient domain distribution obtained in the step (3), selecting the pixel point value of the image corresponding to the gradient domain as the pixel point of the fused image at the pixel point, realizing that the N images are mapped into the same spatial domain through the gradient domain distribution, and obtaining the fused image:

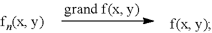

wherein, f(x,y) is the fused gray image obtained after mapping.

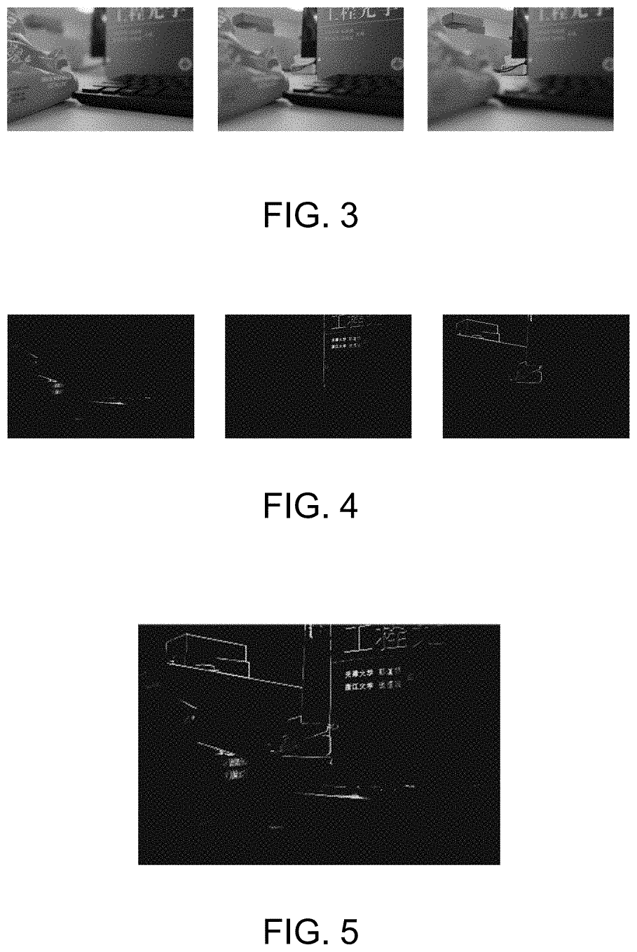

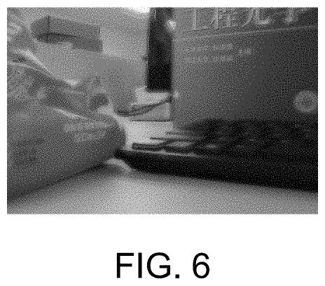

In FIG. 3, the images in the pictures are clearly displayed only at focus positions, that is, the edge and detailed texture information is richer; in the fused image (FIG. 6), the detailed information of the three focus positions is well fused into one image, that is, the detailed information of the objects at different shooting depth positions can be seen from one picture, so that the image fusion effect is effectively realized.

What is claimed is:

1. An image fusion method based on a gradient domain mapping, comprising:
step 1, inputting a plurality of images, which are to be fused, to a processor of a computer by an input unit of the computer, and performing the following steps by the processor of the computer:
performing a gradient domain transform on a plurality of the images, which are to be fused, extracting a maximum gradient modulus value in the plurality of the images corresponding to each of pixel points in a gradient domain as a gradient value of a final fused image at the pixel points, traversing each of the pixel points to obtain a gradient domain distribution of the final fused image, and mapping the plurality of the images, which are to be fused, into a same spatial domain according to the gradient domain distribution, which is obtained, to obtain fused images; and
step 2, outputting the fused images obtained by the processor by an output unit of the computer.

2. The image fusion method based on the gradient domain mapping according to claim 1, wherein performing the steps by the processor specifically comprises:
(1) obtaining a gray image information of each of the plurality of the images from the plurality of the images, which are to be fused:
fₙ(x,y),(x<K,y<L),n=1, 2, . . . , N
wherein, (x,y) is pixel coordinates of gray images, K and L are boundary values of the image in X and Y directions, respectively, and N is a total number of the images;
(2) constructing the gradient domain of N of the images by using Hamiltonian
$$Δ = \frac{\partial }{\partial x} \vec{i} + \frac{\partial }{\partial y} \vec{j} \text{:} grand {f}_{n} ( x , y ) = Δ \cdot {f}_{n} ( x , y ) = \frac{\partial {f}_{n} ( x , y )}{\partial x} \vec{i} + \frac{\partial {f}_{n} ( x , y )}{\partial y} \vec{j} ,$$
wherein, ī, j̅ are unit direction vectors along the X and the Y directions, respectively, and |grand fₙ(x,y)| is a modulus of a gradient in the gradient domain;
(3) extracting a gradient maximum modulus value corresponding to the pixel points (x,y) in the N of the images according to the modulus |grand fₙ(x,y)| of the gradient in the gradient domain, taking a maximum modulus value as the gradient value of a final image at a point (x,y), traversing each of the pixel coordinates (x,y), and finally generating a fused gradient domain distribution at all the pixel points by adopting the method:
grand fₙ(x, y)→grand f(x,y); and
(4) traversing each of the pixel points (x, y) according to the gradient domain distribution obtained in the step (3), selecting a pixel point value of the images corresponding to the gradient domain as the pixel points of the fused images at the pixel points, realizing that the N of the images are mapped into the same spatial domain through the gradient domain distribution, and obtaining the fused images: 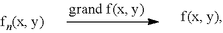
wherein, f(x,y) is a fused gray image obtained after mapping.

3. The image fusion method based on the gradient domain mapping according to claim 2, wherein: in the step (1), a number of the images N is greater than or equal to 2.

4. The image fusion method based on the gradient domain mapping according to claim 2, wherein: in the step (1), the fused images have a same field of view and resolution.

5. The image fusion method based on the gradient domain mapping according to claim 2, wherein: in the step (1), the plurality of the images have different focus depths for objects at different depth positions or a same object.
